(19) United States
(12) Patent Application Publication
(10) Pub. No.: US 2006/0185493 A1
(43) Pub. Date: Aug. 24, 2006

(54) Guitar Soundhole Protector

(75) Inventor: Philip Young Lee, North Hollywood, CA (US)

Correspondence Address: Philip Lee, 10721 Moorpark Street #105, North Hollywood, CA, 91602, US

(73) Assignee: Philip Young Lee, North Hollywood, CA (US)

(21) Appl. No.: 11/307,704

(22) Filed: Feb. 17, 2006

Related U.S. Application Data
(60) Provisional application No. 60/593,881, filed on Feb. 22, 2005.

(51) Int. Cl. G10D 3/00

(52) U.S. Cl. 84/290

(57) ABSTRACT

The present invention generally pertains to the protection of an acoustic guitar. Specifically, the present invention helps minimizes damage that can occur to the finish and wood immediately surrounding the soundhole on said guitar by the use a molded covering that is affixed onto the area around the soundhole. The device is a rounded tube with a lengthwise incision on its outer side, allowing the tube to be seated around the soundhole of the guitar.

The underlying principle behind a wooden body guitar is the use of a transducer that converts mechanical energy into acoustical energy. Guitar strings are connected to the bridge, a piece of wood that acts as an anchor for the strings. The bridge is in turn coupled to the soundboard, the large piece of wood that forms the top of the guitar and serves as an acoustic resonator. When the strings are brought into motion, their vibrational energy is transmitted to the bridge. From there the oscillations of the bridge are passed on to the soundboard, which amplifies the movement. Due to its comparatively larger size, the soundboard is able to induce motion in the surrounding air, which is perceived as sound.

By cutting out a large hole on the soundboard of the guitar, the acoustic properties of the instrument can be increased. Known as a soundhole, this area allows excited air inside the body of the guitar to escape, thereby additionally amplifying the generated sound.

One of the more common methods for activating the guitar strings into motion is by striking them with a plectrum such as a flatpick, essentially a small piece of plastic that is drawn in a perpendicular motion to the strings. Due to the close proximity of the strings to the soundboard, and the rapid motion with which the flatpick can be used across the strings, it is not unusual for the flatpick to strike against the wood surrounding the soundhole.

Particularly susceptible is the area of wood that is encountered towards the bottom half of the downward motion of the flatpick. A pickguard is often used to protect some of this area. It is usually comprised of a large flat piece of plastic that covers the area of wood that is prone to damage. Such pickguards do not make provisions for protecting the area of wood immediately surrounding the soundhole. The wood on most guitars is a very thin sheet coated only by a fine lacquer or other synthetic resin finish that serves also to give the instrument its sheen. On a guitar that is consistently played over time using a flatpick, the wood around the soundhole can be damaged. First the finish is gradually chiseled away, leaving the exposed wood, which then succumbs to the chipping action of the flatpick.

The objective of the present invention is to assist in preventing the destruction of the wood immediately around the soundhole of the guitar.

The invention consists of a rounded tube made of polymer or other pliable material. An incision that runs lengthwise on the outer side of the tube allows the piece to mate with the soundhole of the guitar.

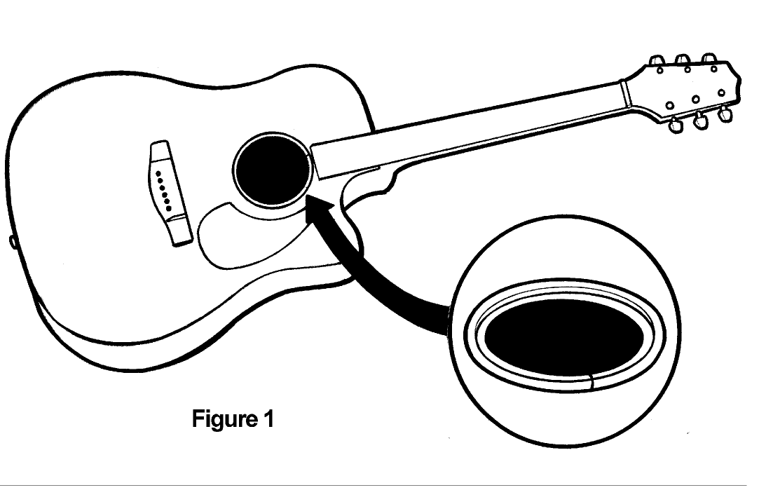

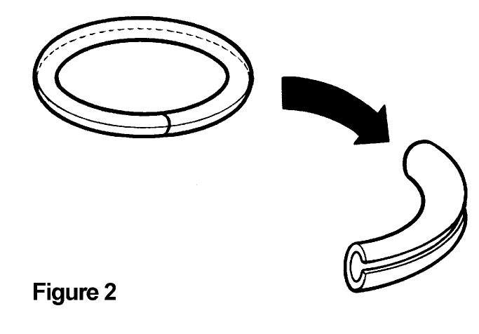

FIG. 1 is an illustration of a guitar, along with an enlarged view of the soundhole showing where the invention would be attached. FIG. 2 is an illustration of the invention, along with a cutaway view showing the lengthwise incision on the outside of the tube.

What is claimed is:

1. A molded piece that attaches to the soundhole of a guitar, helping protect the wood and finish immediately around the soundhole.
